(19) United States
(12) Patent Application Publication
(10) Pub. No.: US 2010/0263632 A1
(43) Pub. Date: Oct. 21, 2010

(54) Control Apparatus and Control Method for Internal Combustion Engine

(75) Inventors: Takao MIYAKE, Hitachi (JP); Masahiro Toyohara, Hitachiota (JP); Yasunaga Hamada, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Automotive Systems, Ltd., Hitachinaka-shi (JP)

(21) Appl. No.: 12/763,732

(22) Filed: Apr. 20, 2010

(30) Foreign Application Priority Data
Apr. 21, 2009 (JP) 2009-103310

(51) Int. Cl. F02M 51/00; F02D 41/00

(52) U.S. Cl. 123/476; 123/478

(57) ABSTRACT

Even when a current waveform and a current value of a current which is supplied to an injector is changed in order to extend a dynamic range of the injector, fuel injection quantity precision is maintained and enhanced. A correction time for correcting an opening/closing delay of the aforementioned injector is variably set by a valve response delay time calculating unit 103 and a selector unit 106 in accordance with change of setting of the current waveform and the current value.

### BACKGROUND OF THE INVENTION

1. Field of the Invention

The present invention relates to a control apparatus and a control method of fuel injection for an internal combustion engine, and particularly to a control apparatus and a control method of fuel injection which perform correction of an opening/closing delay of an injector.

2. Background Art

A fuel injection type internal combustion engine performs calculation for converting a fuel amount which is determined in accordance with an operation state into an injector duration time of an injector, and has the fuel supply amount controlled by a fuel injection control apparatus which controls the drive of the injector in correspondence with the injector duration time.

An injector is of an electromagnetic type, which opens a plunger by the electro magnetic force which is generated by an electric current which flows in an internal solenoid to perform injection of a fuel. The amount of the fuel injected by the injector is mainly determined by a pressure difference between fuel pressure and ambient pressure at the nozzle hole portion of the injector, and the time in which the plunger is kept open and the fuel is injected.

In recent years, from the viewpoint of reduction in a fuel consumption, reduction in the idle speed of an internal combustion engine has been required, and in response to this, the demand for minimization of the fuel amount which the injector can inject tends to be high. Likewise, for reduction in fuel consumption, the occasion increases in which the fuel cut is performed during which fuel injection is not performed when output power of the internal combustion engine is not needed, and the frequency of fuel recover increases in addition. When fuel recover is performed, a small fuel amount corresponding to no load needs to be injected. Further, for the purpose of increasing the output power and enhancing exhaust performance, split injection is performed. This intends to enhance the performance of the internal combustion engine by splitting the fuel originally required for one injection into a plurality of times, and injecting the split fuels at proper timings, and reduction in the fuel injection quantity per one time is required.

Further, in an internal combustion engine, the attempt is made to improve the fuel consumption at the time of being mounted on a vehicle by down sizing. In this case, enhancement in specific power is required by supercharge or the like, and therefore, it is required to increase the maximum injection quantity without increasing the minimum injection quantity of the injector, or with the minimum injection quantity being decreased.

Therefore, the dynamic range (the value obtained by dividing the static injection quantity by the minimum injection quantity) which is required of the injector of an internal combustion engine tends to increase.

As the prior art of the fuel injection control apparatus, the fuel injection control apparatus is known, which determines whether it is a region where the effective minimum pulse width characteristic (Qmin characteristic) is important or not in the operation state of an internal combustion engine and supplies one of a plurality of keeping currents with different current waveforms and small current values by switching, and thereby, enables optimum control of the injector and can maintain the minimum fuel injection quantity characteristic favorable even at the time of high fuel pressure in the case in which the inductance of the solenoid of the injector is small due to miniaturization of the injector (for example, see JP Patent No. 4037632).

Further, as the prior art of the fuel injection control apparatus, the fuel injection control apparatus is known, which includes fuel time calculating means which calculates an injection timing and an injector duration time of an injector based on outputs from a coolant temperature sensor for detecting the temperature of engine coolant, a manifold pressure sensor, an ambient temperature sensor and a ambient pressure sensor, and a battery voltage of an on-board battery, further includes correction coefficient generating means which generates a correction coefficient based on the battery voltage of the on-board battery, an injector opening delay time correcting means which corrects an opening delay time of the injector based on the correction coefficient which is outputted from the correction coefficient generating means, an injector closing delay time correcting means which corrects a closing delay time of the injector, and an injection duration time correcting means which corrects an injector duration time of the injector based on an output from the injector opening delay time correcting means and an output from the injector closing delay time correcting means, and can enhance emission fuel economy over a wide range from the time of high rotation/high load to the time of low rotation/low load by one injector (for example, see JP Patent No. 3917714).

### SUMMARY OF THE INVENTION

In order to perform fuel injection of a proper amount precisely from an injector, the time in which the injector is kept open is set in accordance with the pressure of the fuel, and the opening and closing operation of the injector needs to be quickly performed, whereas at the time of opening and closing the injector, due to the response delay of the current circuit and injector, the valve opening and closing operation of the injector is completed later than the timing at which the fuel injection control apparatus really desires to open and close the valve.

For the valve opening delay, the time to which the time for correcting the valve opening delay is added is set as the injector duration time to the injector in advance, and thereby, the injection quantity can be prevented from being shifted from a desired value. For the valve closing delay, when the injector duration time to the injector is long, the time from which the time for correcting the valve closing delay is subtracted is set as the injector duration time to the injector in advance, and thereby, the injection quantity can be prevented from being shifted from the desired value.

However, when the fuel injection quantity is small, and the injector duration time to the injector is short, if the time from which the valve closing delay time is subtracted is set as the injector duration time in advance, the valve is closed before the injector is not sufficiently opened, and the required injection quantity cannot be injected with high precision.

In regard to this, when the fuel injection quantity to the internal combustion engine is small, and the injector duration time is short, the valve closing delay can be made small by changing the waveform or the magnitude of the current value of the current which is supplied to the injector, and thereby, the injector duration time can be prevented from being a short injector duration time in which the valve is closed before the injector is sufficiently opened.

In a direct cylinder injection type of internal combustion engine, when the engine is in an operation region under a high load, and needs to be supplied with much fuel from the injector, the time in which the fuel can be injected has the upper limitation, and therefore, it is necessary to enhance the fuel pressure to shorten the injector duration time. When the fuel pressure is increased, the force to close the injector is increased, and in correspondence with this, the drive force required for opening the injector is increased. Therefore, the valve opening delay increases. Further, due to production deviation or the like of the injector, the injector is assumed to be closed unintentionally during the injector duration time in which the valve opening of the injector is desired to be maintained.

In order to avoid this phenomenon, when the fuel pressure of the internal combustion engine is high, it is conceivable to change the current waveform which is supplied to the injector, for example, to increase the opening current and the keeping current value to be larger than usual.

Meanwhile, the current which is supplied to the injector is supplied via the fuel injection control apparatus from the power supply, and therefore, from the viewpoint of reduction of the heat generation of the injector and the fuel injection control apparatus and reduction in the fuel consumption, the current value of the current which is supplied to the injector needs to be decreased as much as possible.

In the fuel injection control apparatus which can change the current waveform and the current value of the current which is supplied to the injector, the above described contradiction can be eliminated by changing the current waveform and the current value in accordance with the operation region of the internal combustion engine. More specifically, in only the operation region where a large current is required for the injector, the current value is changed to a large current value, but in the ordinary region, a necessary and sufficient current which is lower than this is supplied, and in the operation region where the minimum injection quantity needs to be reduced, the current waveform is changed to a proper current waveform, whereby the injection characteristic and heat generation reduction required from the injector can be made compatible.

However, when the waveform or the magnitude of the current value of the current which is supplied to the injector is changed, the degrees of the aforementioned valve opening delay and valve closing delay change, and with the same correction time and injector duration time to the injector as those before the change, there is the fear that a deviation occurs from the desired fuel injection quantity, and desired fuel injection quantity control precision cannot be maintained. In regard to this, the aforementioned prior arts cannot sufficiently respond to the demand for such fuel injection quantity precision.

An object of the present invention is to provide a control apparatus and a control method which can maintain and enhance fuel injection quantity precision even if a waveform and a value of a current which is supplied to an injector are changed in order to increase a dynamic range of the injector.

In order to attain the above-described object, a control apparatus for an internal combustion engine according to the present invention is a control apparatus for an internal combustion engine which converts an injection quantity of a fuel which is supplied to the internal combustion engine into a valve opening duration time of an electromagnetic type injector, calculates a valve opening/closing delay of the said injector as a correction time, corrects the said valve opening duration time in accordance with said correction time to control an injector duration time of the said injector, and controls a fuel injection quantity, and has current waveform/current set value changing portion which can change a setting of at least any one of a current waveform or a current value of a current which is supplied to the said injector, and valve response delay time calculating portion which variably sets said correction time for correcting the opening/closing delay of the said injector in accordance with a change of setting of the current waveform and the current value by the said current waveform/current set value changing portion.

Further, in order to attain the above described object, a control method for an internal combustion engine according to the present invention is a control method for an internal combustion engine for controlling a fuel injection quantity by converting an injection quantity of a fuel which is supplied to the internal combustion engine into a valve opening duration time of an electromagnetic type injector, calculating a valve opening/closing delay of the said injector as a correction time, and correcting the said valve opening duration time in accordance with the said correction time to control an injector duration time of the said injector, wherein the said correction time for correcting the opening and closing delay of the said injector is changed in accordance with change of setting of at least any one of a current waveform or a current value of a current which is supplied to the said injector.

According to the control apparatus and the control method for an internal combustion engine according to the present invention, the correction time for correcting the opening and closing delay of the injector is changed in accordance with change of setting of the current waveform or the current value of the current which is supplied to the injector, and therefore, even if the current waveform and the current value of the current which is supplied to the injector are changed in order to extend the dynamic range of the injector, the fuel injection quantity precision is maintained and enhanced.

### BRIEF DESCRIPTION OF THE DRAWINGS

FIG. 1 is a configuration diagram of an internal combustion engine system to which a fuel injection control apparatus according to an embodiment of the present invention is mounted.

FIG. 2 is a circuit diagram showing a configuration of the fuel injection control apparatus according to the embodiment of the present invention.

FIG. 3 is a timing chart showing relationship of an energizing current flowing in a solenoid of an injector and an on-off valve of a plunger of the injector.

FIG. 4 is a timing chart showing energization control of the injector by the fuel injection control apparatus of the present embodiment.

FIG. 5 is a timing chart showing the energizing current flowing to the solenoid of the injector and improvement of valve closing delay of the injector when a driver signal width of the injector is small.

FIG. 6 is a timing chart showing the energizing current flowing to the solenoid of the injector and improvement of the response delay of the injector 5 due to increase in the fuel pressure.

FIG. 7 is a graph showing the fuel injection characteristic in the case of drive by changing a waveform of a current which is supplied to the solenoid of the injector by the fuel injection control apparatus according to the embodiment.

FIG. 8 is a block diagram showing the details of the fuel injection control apparatus of the present embodiment.

FIG. 9 is a block diagram of a main part of the fuel injection control apparatus of the present embodiment.

FIG. 10 is a flowchart showing a processing flow of calculating an injector duration time to the injector in the fuel injection control apparatus according to the embodiment of the present invention.

FIG. 11 is a timing chart showing an energizing current flowing in the injector when a high voltage power supply fails in the fuel injection control apparatus according to the present embodiment.

### DETAILED DESCRIPTION OF THE PREFERRED EMBODIMENTS

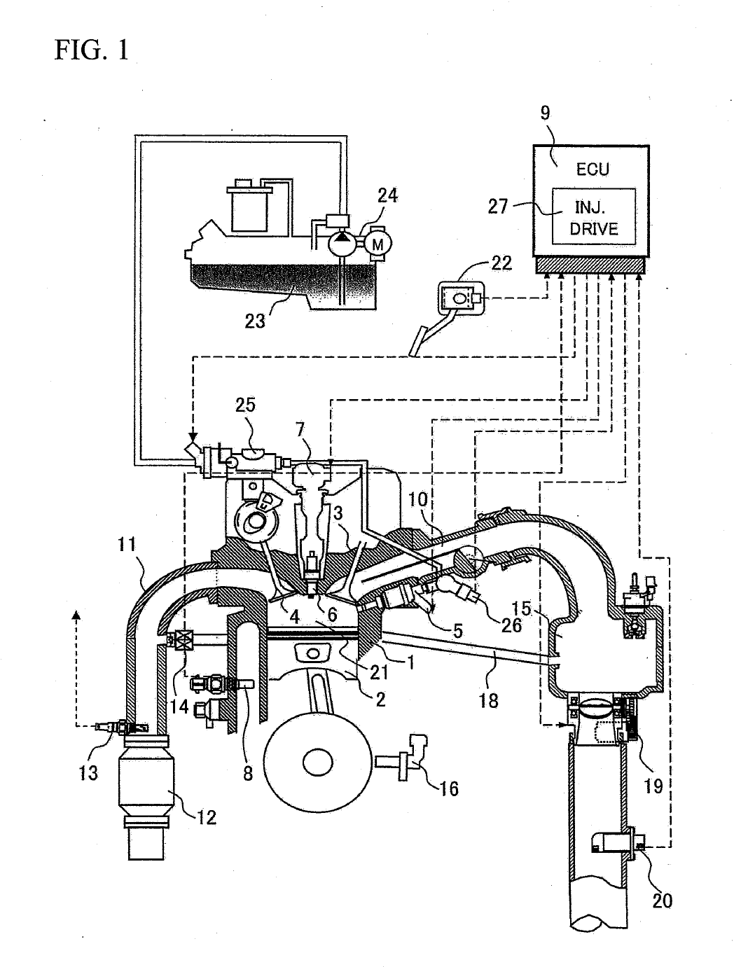

Hereinafter, with use of FIGS. 1 to 11, a configuration and an operation of a fuel injection control apparatus according to an embodiment of the present invention will be described.

First, with use of FIG. 1, a configuration of an internal combustion engine system to which the fuel injection control apparatus according to the present embodiment is mounted will be described. FIG. 1 is a configuration diagram of the internal combustion engine system to which the fuel injection control apparatus according to a first embodiment of the present invention is mounted.

An internal combustion engine (engine) 1 has a piston 2, an intake valve 3 and an exhaust valve 4. Intake air passes through an air flowmeter (AFM) 20, has a flow rate regulated by a throttle valve 19, and is supplied to a combustion chamber 21 of the engine 1 through an intake pipe 10 and the intake valve 3 from a collector 15 which is a branching section. A fuel is supplied to a high pressure fuel pump 25 by a low pressure fuel pump 24 from a fuel tank 23, and is increased to the pressure needed for fuel injection by the high pressure fuel pump 25. The fuel increased in pressure by the high pressure fuel pump 25 is directly injected and supplied to the combustion chamber 21 of the engine 1 from the injector 5, and is ignited by an ignition coil 7 and an ignition plug 6. The pressure of the fuel which is supplied to the injector 5 is measured by a fuel pressure sensor 26.

The exhaust gas after combustion is exhausted to an exhaust pipe 11 through the exhaust valve 4. The exhaust pipe 11 is equipped with a three-way catalyst 12 for purifying the exhaust gas.

The exhaust pipe 11 and the collector 15 are connected by an EGR passage 18. An EGR valve 14 is provided halfway through the EGR passage 18. The opening degree of the EGR valve 14 is controlled by an ECU 9, and the exhaust gas in the exhaust pipe 11 is returned to the intake pipe 10 in accordance with necessity.

The ECU (engine control unit) 9 is an electronic control type including a microcomputer, and includes a fuel injection control apparatus 27. The ECU 9 receives a crank angle signal of a crank angle sensor 16 of the engine 1, an air amount signal of the AFM 20, an oxygen concentration signal of an oxygen sensor 13 which detects the oxygen concentration in exhaust gas, an accelerator opening degree signal of an accelerator opening degree sensor 22, and a fuel pressure signal of a fuel pressure sensor 26, calculates a required torque to the engine from the accelerator opening degree, performs determination of the idle state and the like, calculates an intake air amount needed for the engine 1, and outputs the opening degree signal corresponding to it to the throttle valve 19.

The ECU 9 has an engine speed detecting section which calculates an engine speed from the crank angle signal of the crank angle sensor 16.

The fuel injection control apparatus 27 calculates the fuel amount corresponding to the intake air amount, outputs the current for the injector 5 to perform fuel injection, and outputs an ignition signal to the ignition plug 6.

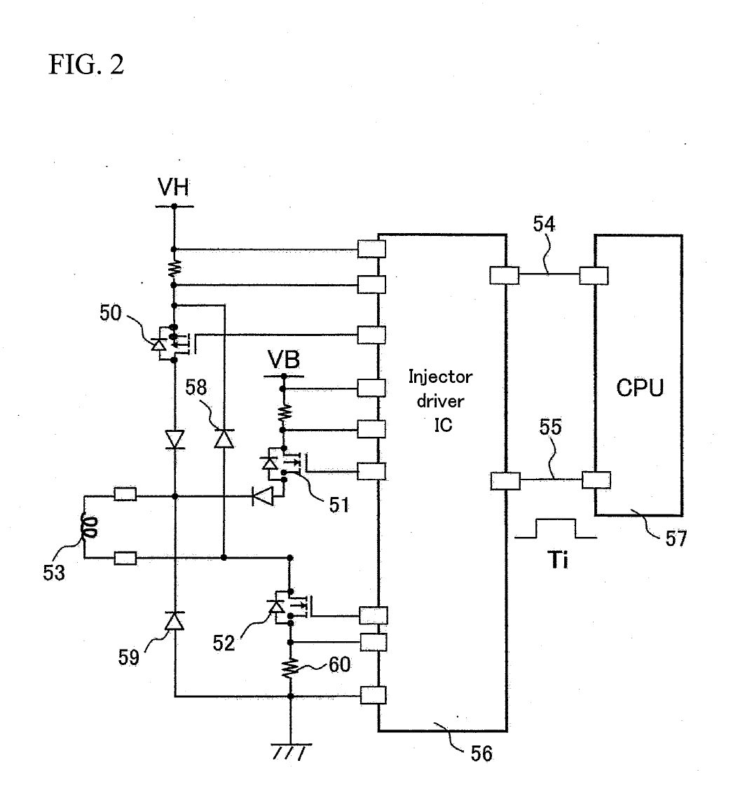

Next, with use of FIG. 2, the configuration of the fuel injection control apparatus 27 according to the present embodiment will be described. The fuel injection control apparatus 27 is generally incorporated in the ECU 9 shown in FIG. 1.

A CPU 57 of the fuel injection control apparatus 27 calculates a proper injector duration time and injection start timing in accordance with the operation state of the engine 1, and transmits a driver signal Ti corresponding to the injector duration time to an injector driver IC 56 through a driver signal sending line 55. The injector driver IC 56 which receives the driver signal Ti switches on/off of a high voltage side switching element 50, a low voltage side switching element 51 and a ground side switching element 52 to supply an energizing current to a solenoid (electromagnetic solenoid for valve opening drive) 53 of the injector 5.

The high voltage side switching element 50 is connected to between a high voltage power supply VH and a high voltage side terminal of the solenoid 53. The high voltage power supply VH is, for example, 60 V, and is generated by stepping-up the voltage of the battery by a DC/DC converter or the like.

The low voltage side switching element 51 is connected to between a low voltage power supply VB and the high voltage side terminal of the solenoid 53. The low voltage power supply VB is, for example, 12 V corresponding to the battery voltage.

The ground side switching element 52 is connected to between a low voltage side terminal of the solenoid 53 and a ground potential.

The injector driver IC 56 detects the value of the current flowing in the solenoid 53 by a current detecting resistance element 60, and can hold the target current value to energize the solenoid 53 by switching on/off of the switching elements 50, 51 and 52.

Diodes 58 and 59 are provided for discharging the current flowing in the solenoid 53. When the low voltage side switching element 51 and the ground side switching element 52 are both off, the current is rapidly discharged by the diodes 58 and 59.

The injector driver IC 56 performs transmission and reception of data to and from the CPU 57 through a communication line 54. The injector driver IC 56 has the function of being capable of changing the waveform and the magnitude of the current value of the current which is supplied to the solenoid 53 in accordance with the data of the communication line 54. Therefore, the CPU 57 can change the current value and current waveform of the current which energizes the solenoid 53 in accordance with the operation state of the internal combustion engine.

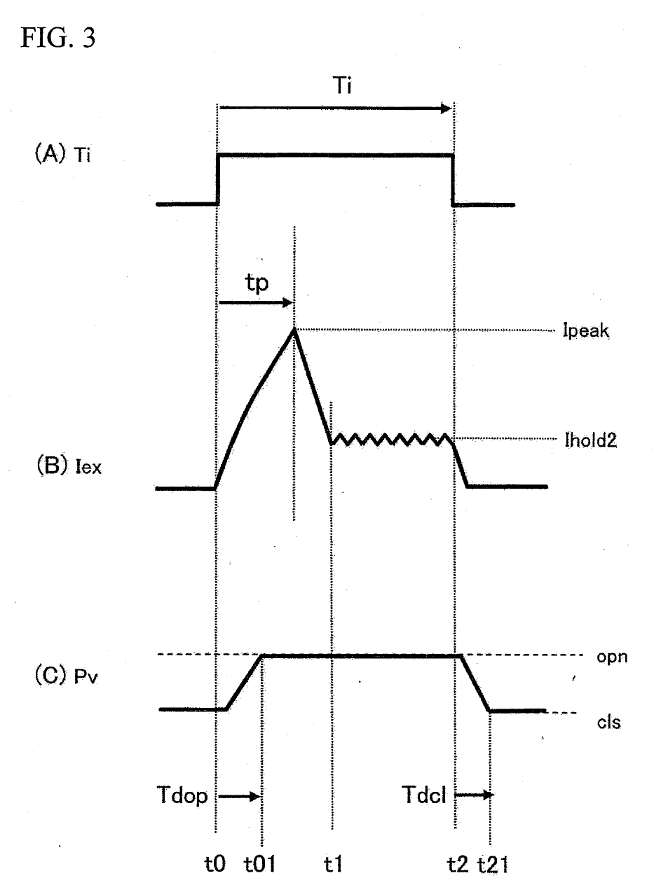

Next, the relationship of the energizing current flowing in the solenoid 53 of the injector 5 and the on-off valve of the plunger of the injector 5 will be described by using a timing chart of FIG. 3. FIG. 3 shows the basic characteristics in the case where the injector duration time to the solenoid 53 of the injector 5 is usual, and among them, FIG. 3(A) shows the driver signal Ti which is sent to the injector driver IC 56 from the CPU 57, FIG. 3(B) shows an energizing current Iex flowing in the solenoid 53, and FIG. 3(C) shows a plunger position Pv at the time of driving the injector 5. In FIG. 3(C), opn represents the valve opening position of the injector 5, and cls represents the valve closing position of the injector 5.

At a time t0, when the fuel injection start timing calculated by the CPU 57 comes, the driver signal Ti is transmitted to the injector driver IC 56 as shown in FIG. 3(A). The injector driver IC 56 simultaneously turns on the high voltage side switching element 50 and the ground side switching element 52 of the fuel injection control apparatus 27 shown in FIG. 2 at the time of rise of the signal of the driver signal Ti, and supplies an opening current required for rapid opening of the solenoid 53 as shown in FIG. 3(B). A high voltage is applied to the solenoid 53 from the high voltage power supply VH, and an opening current is supplied.

A shown in FIG. 3(B), when the current value of the energizing current Iex reaches a peak current value Ipeak after a time tp elapses from a time t0, the injector driver IC 56 turns off the high voltage side switching element 50. The peak current value Ipeak is, for example, 11 A. At this time, the electric charge which is given to the solenoid 53 circulates in the diode 59 and the solenoid 53, and dissipates energy as heat. The time tp is the reaching time from the rise of the driver signal Ti to the peak current value Ipeak which is the opening current value.

At a time t1, when the current value of the energizing current Iex becomes close to a second hold target value Ihold2, which can maintain the valve opening, of the solenoid 53, the injector driver IC 56 turns on the low voltage side switching element 51 and the ground side switching element 52, and energizes the solenoid 53 from the low voltage power source VB. The injector driver IC 56 turns on and off the low voltage side switching element 51 so as to hold the current value at the second hold target value Ihold2 which is such a degree as to be able to maintain the valve opening. For example, the second hold target value Ihold2 is 3 A.

At a time t2, when the driver signal Ti falls, supply of the current to the solenoid 53 is stopped at the same time.

Opening and closing (time points t01and t21) of the injector 5 delays from the time points t0 and t2 at which the fuel injection control apparatus 27 actually desires to open and close the valve due to a response delay of the current due to the internal circuit of the fuel injection control apparatus 27 and harness up to the injector 5, and a response delay of the generated electro magnetic force and the plunger. As shown in FIG. 3(C), at the time of valve opening, the plunger of the injector 5 completely moves to a valve opening position opn after a response delay time Tdop, and at the time of closing the valve, the plunger of the injector 5 completely moves to a valve closing position cls after a response delay time Tdcl.

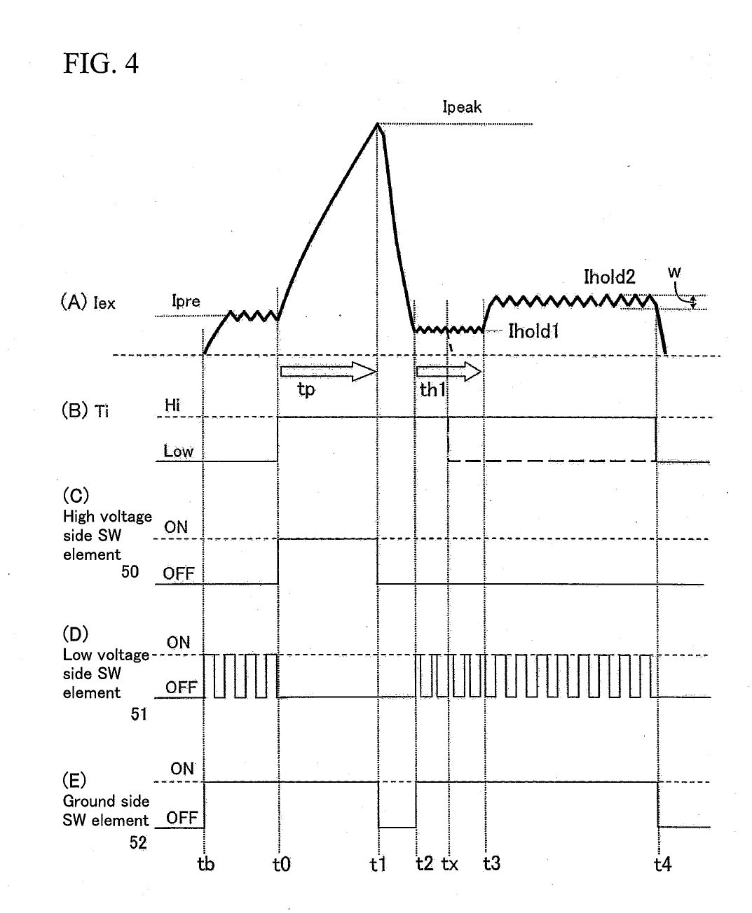

Energization control of the solenoid 53 according to the fuel injection control apparatus of the present embodiment will be described with reference to a timing chart shown in FIG. 4. FIG. 4(A) shows the energizing current Iex which flows to the solenoid 53. FIG. 4(B) shows the driver signal Ti which is sent to the injector driver IC 56 from the CPU 57. FIG. 4(C) shows the on/off state of the high voltage side switching element 50. FIG. 4(D) shows the on/off state of the low voltage side switching element 51. FIG. 4(E) shows the on/off state of the ground side switching element 52.

At a time t0, when the solenoid 53 is energized for a fixed time with a pre-charge current value Ipre as shown in FIG. 4(A) during the time tb to the time t0 after which the driver signal Ti reaches a high level as shown in FIG. 4(B), the injector driver IC 56 turns on the low voltage side switching element 51 and the ground side switching element 52 during the pre-charge current carrying period (tb to t0) as shown in FIGS. 4(D) and 4(E).

Thereby, a voltage is applied to the solenoid 53 from the low voltage power supply VB, and by the low voltage side switching element 51 repeating on and off, namely, by pulse control (duty ratio control), energization is performed with the pre-charge current value Ipre to be the target value being kept. The pre-charge current value Ipre is the current value which is within the range of the current value and time by which the injector 5 is not opened, and may be, for example, about 1.5 A.

Thus, by performing energization with the pre-charge current value Ipre prior to the rise of the driver signal Ti, the reaching time tp from the rise of the driver signal Ti to the peak current valve Ipeak can be decreased. Thereby, the valve opening delay of the solenoid 53 can be made small.

At the time t0, when the fuel injection start timing which is calculated by the CPU 57 comes, the driver signal Ti is transmitted to the injector driver IC 56 as shown in FIG. 4(B). The injector driver IC 56 simultaneously turns on the high voltage side switching element 50 and the ground switching element 52 as shown in FIG. 4(C) and (E) at the time of rise of the driver signal Ti, and supplies the opening current required for rapid opening of the valve, of the solenoid 53. A high voltage is applied to the solenoid 53 from the high voltage power supply VH, and as shown in FIG. 4(A), the opening current is supplied.

At the time t1, when the current value of the energizing current Iex reaches the peak current value Ipeak (for example, 11 A) as shown in FIG. 4(A), the injector driver IC 56 turns off the high voltage side switching element 50 and the ground switching element 52 as shown in FIG. 4(C). Thereby, the electric charge of the solenoid 53 circulates in the diode 59 and the solenoid 53, and is dissipated as heat energy. Further, at this time, by simultaneously turning off the ground side switching element 52 as shown in FIG. 4(E), the electric charge of the solenoid 53 is regenerated and returned to the high voltage power supply VH via the diode 58, and is rapidly reduced.

At the time t2, when the current value of the energizing current Iex becomes close to a first hold target value (first keeping current value) Ihold1 by which the current value of the energizing current Iex cannot maintain the valve opening of the injector 5 as shown in FIG. 4(A), the injector driver IC 56 turns on the low voltage side switching element 51 and the ground side switching element 52 as shown in FIG. 4(D) and (E), and the solenoid 53 is energized from the low voltage power supply VB. The current value of the energizing current Iex at this time is set at the first hold target value Ihold1, for example, about 1 A by which the valve opening of the injector 5 cannot be maintained, by duty ratio control of the low voltage side switching element 51. The time in which the first hold target value Ihold1 is maintained is set at a time th1 which is set in advance.

The set time th1 is about 0.2 ms. The first hold target value Ihold1 and the set time th1 can be variably set to an appropriate value in accordance with the operation state of the internal combustion engine, for example, the engine speed.

The first hold target value Ihold1 may be changed in accordance with the fuel pressure. In this case, the first current value Ihold1 is increased in correspondence with increase in the fuel pressure, whereas the first current value Ihold1 is decreased in correspondence with decrease in the fuel pressure.

Further, the first hold target value Ihold1 and the set time th1 may be changed in accordance with the alcohol concentration of the fuel and the fuel temperature. The upper limit is set to the set time th1. This is for avoiding valve closing because the valve is likely to be closed if the first hold target value Ihold1 is maintained for an excessively long time.

At a time t3 when the set time th1 elapses, the current value of the energizing current Iex is changed to the second hold target value (second keeping current value) Ihold2 by which the injector 5 can stay open. The second hold target value Ihold2 is, for example, about 3 A, and the second hold target vale Ihold2 is set by the duty ratio control of the low voltage side switching element 51.

If the current value of the energizing current Iex continues to be kept at the first keeping current value Ihold1 at the time t2and afterwards, the injector 5 cannot stay open and closes. Therefore, after the predetermined time th1 elapses from the time t2, the current value of the energizing current Iex is changed to the second hold target value Ihold2 by which the injector 5 can stay open.

The first keeping current value Ihold1 is the current value which is sufficiently smaller than the second keeping current value Ihold2 which is necessary and sufficient for keeping the injector 5 open, and closes the injector 5 if energization is continued with the first keeping current value Ihold1. The difference of the absolute values of the first keeping current value Ihold1 and the second keeping current value Ihold2 is made sufficiently larger than the variation (for example, a variation width w shown in FIG. 4) of the current value which is seen when the current is held.

At a time t4, with termination of the fuel injection pulse calculated by the CPU 57, the driver signal Ti becomes a low level as shown in FIG. 4(B), and all of the high voltage side switching element 50, the low voltage side switching element 51 and the ground side switching element 52 are turned off, and energization to the solenoid 53 is finished.

In the example shown in the drawing, the pulse width Ti of the driver signal is, for example, about 1.0 ms. The time t2is about 0.4 ms after the time t0, and the time t3 is about 0.6 ms from the time t0.

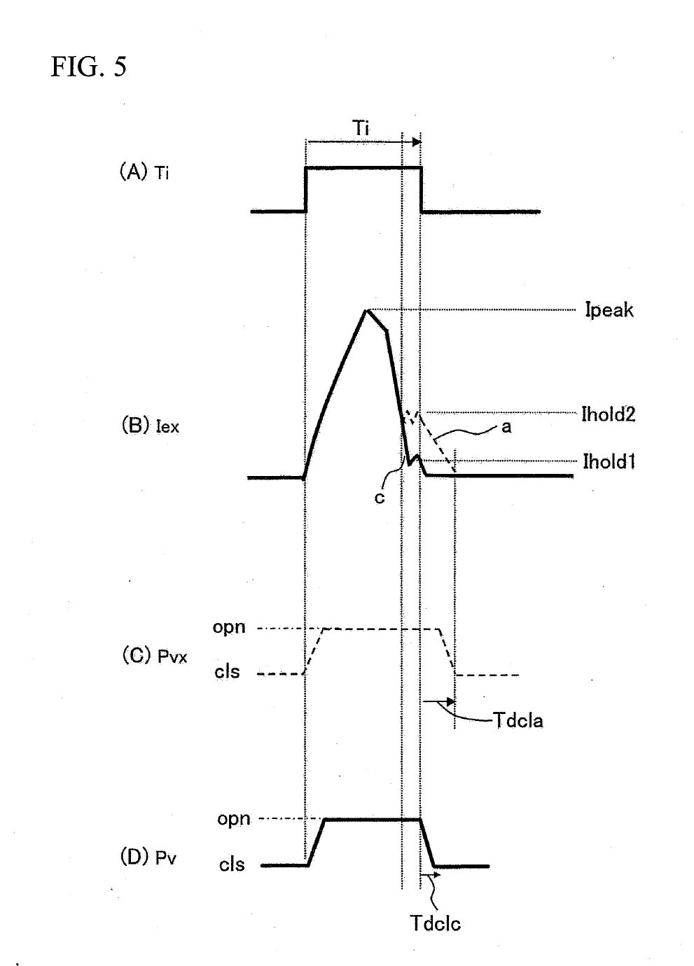

Next, the energizing current flowing to the solenoid 53 of the injector 5 and improvement in a valve closing delay of the injector 5 will be described with reference to FIG. 5. FIG. 5 shows the relationship of the energizing current flowing to the injector 5 and the on/off valve of (the plunger) of the injector 5 when the pulse width of the driver signal Ti of the injector 5 is small. This assumes the case in which, for example, the driver signal Ti becomes a low level at a time tx as shown by the broken line in FIG. 4(B).

FIG. 5(A) shows the driver signal Ti. FIG. 5(B) shows the current value of the energizing current Iex. FIG. 5(C) shows a plunger position Pvx at the time of driving the ordinary injector 5. FIG. 5(D) shows a plunger position Pv at the time of driving the injector 5 according to the present embodiment. In FIG. 5(C) and (D), opn represents the valve opening position of the injector 5, and cls represents the valve closing position of the injector 5.

In FIG. 5(B), the broken line a represents an ordinary current waveform at the time when the high voltage side switching element 50 and the ground side switching element 52 are simultaneously turned off to perform electric discharge rapidly after energization is performed with the peak current value Ipeak which is an opening current similarly to the energizing current shown in FIG. 3, and the current value Iex is kept at the second keeping current value Ihold2. In this case, a delay accompanies until the current disappears to zero from the second keeping current value Ihold2 after energization by the peak current value Ipeak, and therefore, there is the limitation in decreasing a valve closing delay Tdcla as shown in FIG. 5(C).

In contrast with this, in FIG. 5(B), as shown by the solid line c, after the current value of the energizing current Iex reaches the peak current value Ipeak, the current value is rapidly reduced to the vicinity of the first keeping current value Ihold1 at which the valve opening cannot be maintained, and at the time point when the current value becomes the first keeping current value Ihold1, energization to the injector 5 is stopped, whereby the delay until the current disappears to zero can be made extremely small.

Thereby, as shown in FIG. 5(D), the valve closing delay Tdclc when the pulse width of the driver signal Ti is small can be made smaller than usual.

Thus, by keeping the current at the first keeping current Ihold1 which is of such a degree that is smaller than the second keeping current value Ihold2 and cannot maintain the valve opening before the current is kept at the second keeping current value Ihold2, the current inside the solenoid 53 can be temporarily made small. Accordingly, at a time tx of FIG. 4, when energization to the solenoid 53 is finished, the solenoid 53 is rapidly closed, and even when the pulse width of the driver signal Ti is short, the valve closing delay can be made small.

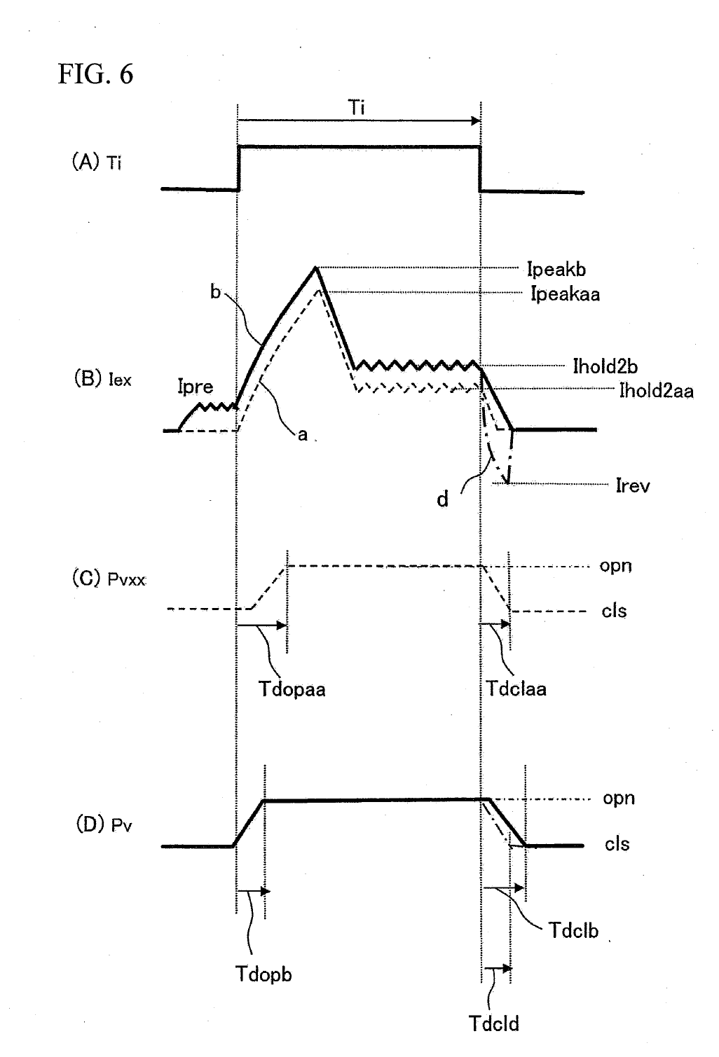

Next, the energizing current flowing to the solenoid 53 of the injector 5 and improvement in response delay of the injector 5 by increase in fuel pressure will be described with reference to FIG. 6.

FIG. 6(A) shows the driver signal Ti. FIG. 6(B) shows the energizing current Iex. FIG. 6(C) shows a plunger position Pvxx at the time of ordinary drive of the injector 5. FIG. 6(D) shows the plunger position Pv at the time of drive of the injector 5 according to the present embodiment. In FIG. 6(C) and (D), opn also represents the valve opening position of the injector 5, and cls also represents the valve closing position of the injector 5.

In FIG. 6(B), the dotted line a shows the energizing current when the internal combustion engine is in an ordinary operation region similarly to the energizing current shown in FIG. 3. When the fuel pressure is high, the drive force necessary for opening the injector 5 is large when the valve is open, and therefore, a valve opening delay Tdopaa becomes larger than usual as shown in FIG. 6(C). Meanwhile, as shown by the solid line b of FIG. 6(B), when energization by the pre-charge current Ipre value is performed, and the peak current value is further increased to a current value Ipeakb which is higher than a current value Ipeakaa at an ordinary time, rise of the current flowing to the solenoid 53 of the injector 5 becomes earlier by energization by the pre-charge current value Ipre, in addition to which, the electro magnetic force generated due to increase in the peak current value increases, and the valve opening force of the plunger becomes large. Therefore, the valve opening delay can be made small as shown in Tdopb of FIG. 6(D).

Further, by increasing the second holding current to Ihold2b from Ihold2aa, the injector 5 can be prevented from unintentionally closing even when the fuel pressure is high. However, in this case, the current value when the current supply to the solenoid 53 is cut off becomes large, and therefore, valve closing delay is increased as Tdclb shown by the solid line of FIG. 6(D).

In regard to this, in FIG. 6(B), when the current which is supplied to the solenoid 53 is cut off, an anti-energizing current Irev shown by the dashed line d is passed to the solenoid 53, whereby the energizing current flowing to the solenoid 53 is caused to disappear quickly, and the speed at which the plunger returns to the valve closing position can be made high. Thereby, the valve closing delay of the injector 5 can be decreased to Tdcld of FIG. 6(D).

As described above with use of FIGS. 5 and 6, by changing the waveform and the current value of the energizing current Iex which drives the injector 5, the valve opening/closing delay can be decreased. When the engine is in the operation region where the minimum injection quantity of fuel is desired to be injected by making the valve closing delay small, or when the engine is in the operation region under high load where the fuel pressure is desired to be increased, the valve opening and closing characteristics of the injector 5 are improved by changing the current waveform from the ordinary current waveform, and a desired amount of fuel can be injected with high precision.

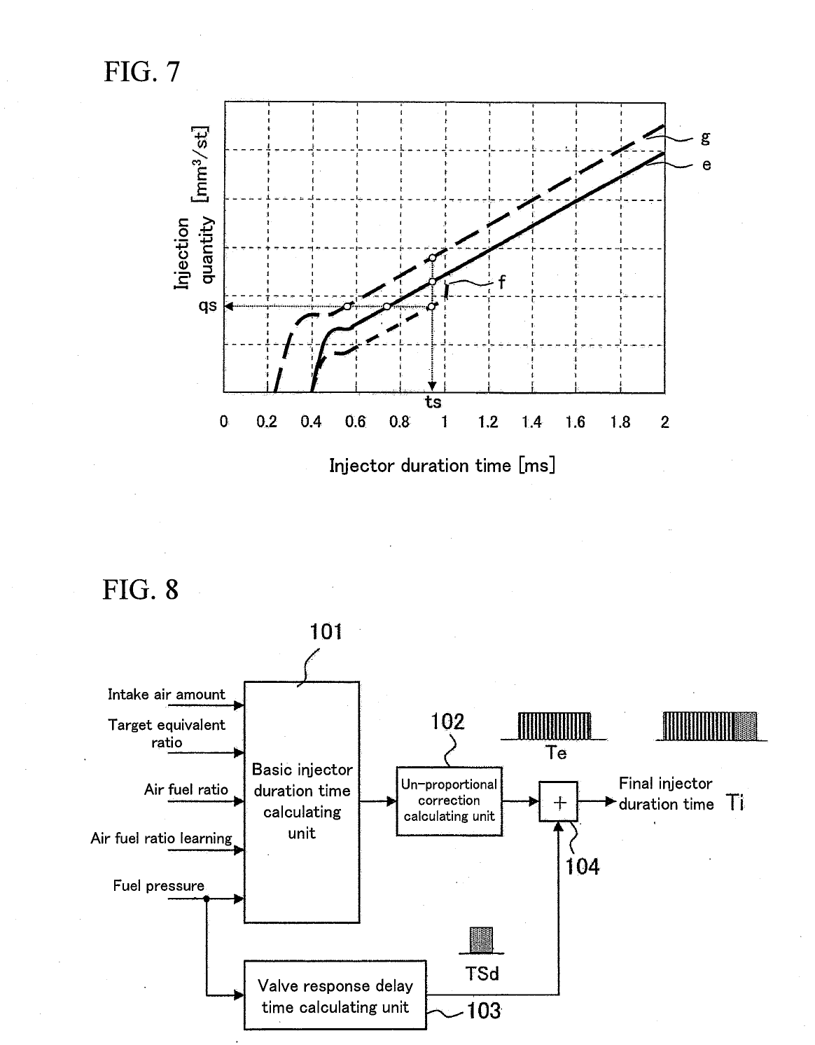

Next, the fuel injection characteristics at the time of driving by changing the waveform of the current which is supplied to the solenoid 53 of the injector 5 by the fuel injection control apparatus 27 according to the present embodiment will be described with reference to FIG. 7. FIG. 7 is a graph schematically showing the relationship of the injector duration time to the solenoid 53 of the injector 5 and the fuel injection quantity.

A line e of FIG. 7 represents the injection quantity characteristic in the standard current waveform. The injection quantity characteristic when the current waveform is changed to the waveform as shown in, for example, FIG. 4(A) is as the broken line shown by a line f. The reason why the line f overlays the line e with the injector duration time 1.0 ms is that the time in which the current value (the first keeping current value Ihold1) with which the injector 5 cannot stay open is from the energization pulse start time t0to the time t3 after the lapse of 1.0 ms, as shown in FIG. 4(A).

When the injector duration time is within the range from 0.4 to 1.0 ms, the current value at the time of finishing the energization is the first keeping current value Ihold1, and therefore, the current waveform becomes the one shown by the solid line c of FIG. 5(B), and the valve closing delay becomes small as shown in FIG. 5(D). Therefore, even with the same injector duration time as the standard current waveform, the injection quantity decreases, and therefore, the injection quantity characteristic shown by the line f of FIG. 7 is provided. After the injector duration time becomes 1.0 ms or longer, the current value at the time of finishing the energization becomes the second keeping current value Ihold2 of FIG. 4(A), and therefore, the valve closing delay becomes similar to a usual delay as shown in FIG. 3(C), and the injection quantity characteristic becomes the same as the line e.

Next, when the current waveform is changed to the waveform as shown by the line b of FIG. 6(B), for example, the injection quantity characteristics become as shown by a line g of FIG. 7. By performing energization by the pre-charge current value Ipre, and thereafter, increasing the peak current to Ipeakb, whereby valve opening delay can be reduced, and therefore, the fuel can be injected before the lapse of the injector duration time 0.4 ms.

Further, in the waveform shown by the line b of FIG. 6(B), the second keeping current amount Ihold2b which is larger than the ordinary keeping current is used, and therefore, the valve closing delay Tdclb becomes large as shown in FIG. 6(D). From this, even with the same injector duration time as the standard current waveform, the injection quantity increases, and therefore, the injection quantity characteristic shown by the line g in FIG. 7 is provided.

When the waveform of the current, which is supplied to the solenoid 53 of the injector 5, is changed in accordance with the injection quantity characteristic shown in FIG. 7, the injection quantity characteristic is also changed to the lines e, f and g. At this time, at the same injector duration time ts, the injection quantities have different values respectively.

FIG. 8 shows one embodiment of the fuel injection control apparatus 27 according to the present invention. The fuel injection control apparatus 27 of the present embodiment has a basic injector duration time calculating unit 101, an un-proportional correction calculating unit 102 and a valve response delay calculating unit 103.

The basic injector duration time calculating unit 101 performs calculations of an intake air amount taken in by the internal combustion engine, a target equivalent ratio for setting a certain target value in a mixture ratio (air fuel ratio) of the intake air amount and a fuel amount, an air fuel ratio correction for performing correction so that the equivalent ratio becomes the target equivalent ratio from the air fuel ratio obtained from the remaining oxygen concentration in exhaust gas, air fuel ratio learning for storing a shift of the air fuel ratio in the case without the air fuel ratio correction for each operation region of the engine 1, and correcting the fuel injection quantity in advance as the learning amount, fuel pressure correction for performing correction of the fuel injector duration time by fuel pressure detected by the fuel pressure sensor included in the common rail and the like, and calculates a basic injector duration time.

After calculation of the basic injector duration time, the un-proportional correction calculating unit 102 performs un-proportional correction for correcting un-proportionality of the basic injector duration time and fuel flow rate which is caused by the characteristic of the injector 5, and calculates an injector duration time Te.

As described with use of FIG. 3, a response delay accompanies the valve opening and closing of the injector 5, and the response delay mainly depends on the fuel pressure. In regard to this, in the valve response delay calculating unit 103, a valve response delay time (correction time) Tsd corresponding to the fuel pressure is calculated, and in the calculating unit 104, the sum of the correction time TSd and the injector duration time Te is obtained, whereby the final injector duration time Ti to the injector 5 can be calculated.

For example, when an ordinary current waveform is adopted as the current waveform shown in FIG. 3(B), and setting of the current waveform and the current value of the current for energizing the solenoid 53 of the injector 5 is changed as in FIG. 4(A) and FIG. 6(B) in correspondence with the operation state of the engine 1, the value of the injected fuel amount becomes a different value even when the same injector duration time Ti is set as described with use of FIG. 7. Therefore, only by the correction by the valve response delay time TSd corresponding to the fuel pressure, the fuel injection quantity after change of the setting of the current waveform and the current value does not correspond to the fuel injection quantity in the case of the ordinary current waveform. As a result, a shift from the target equivalent ratio occurs, and is likely to hinder enhancement of the performance of the engine 1.

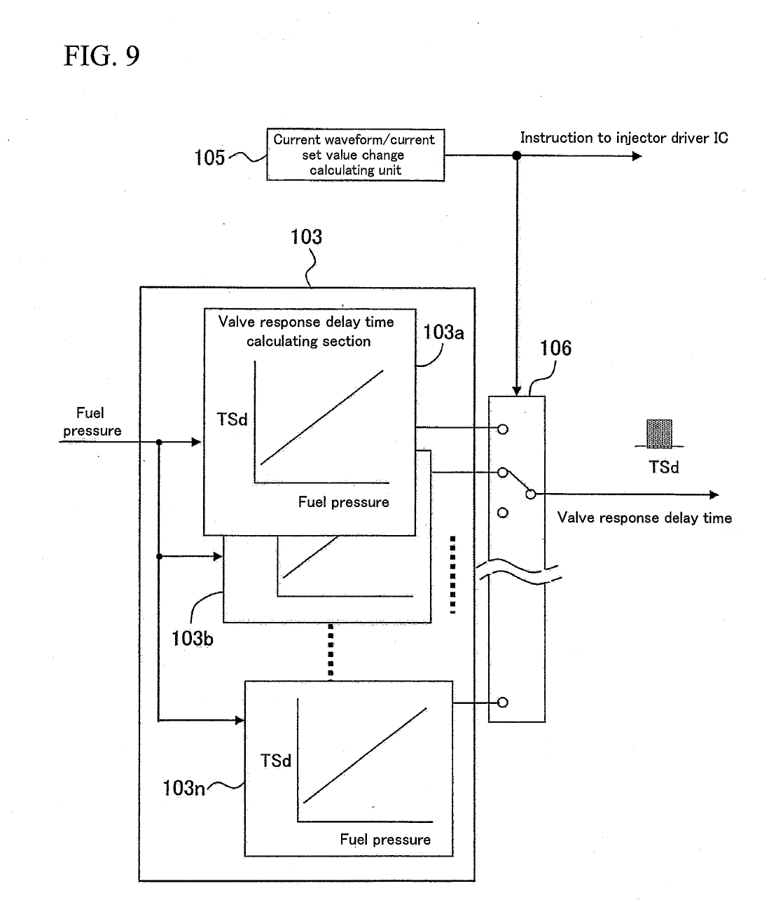

Next, one embodiment of the fuel injection control apparatus 27 corresponding to the case of changing the setting of the current waveform and the current value of the current for energizing the solenoid 53 of the injector 5 will be described with reference to FIG. 9.

The fuel injection control apparatus 27 of the present embodiment has a current waveform/current value calculating unit 105 which performs change of setting of the current waveform and the current value of the current for energizing the solenoid 53 of the injector 5 as described by using FIGS. 4 to 6, and instructs the injector driver IC 56 about it.

The valve response delay time calculating unit 103 has a plurality of calculating sections which calculate the valve response delay time TSd in accordance with the fuel pressure as shown by reference numerals and characters 103a to 103n. The calculating sections 103a to 103n calculate the valve response delay time TSd corresponding to the fuel pressure with the respective individual characteristics.

A selector unit 106 which selects one of the valve response delay times TSd calculated by the respective calculating sections 103a to 103n of the valve response delay time calculating unit 103 based on the instruction outputted by the current waveform/current value calculating unit 105 which is the current waveform/current setting value changing portion is provided at the rear stage of the valve response delay time calculating unit 103.

The selector unit 106 may be embodied by software processing of a computer.

When the engine 1 is in the ordinary operation region, the fuel injection control apparatus 27 performs energization to the solenoid 53 of the injector 5 with the current waveform shown in FIG. 3(B). As the valve response delay time TSd corresponding to the current waveform in this case, for example, the one calculated in the calculating section 103a is selected by the operation of the selector unit 106 based on the instruction from the current waveform/current value calculating unit 105. In this manner, the valve response delay time calculating portion is configured by the valve response delay time calculating unit 103 and the selector unit 106.

When the fuel injection control apparatus 27 performs energization to the solenoid 53 of the injector 5 with the current waveform shown in FIG. 4(A), for example, the one calculated in the calculating section 103b is selected by the similar selecting operation. Further, when the fuel injection control apparatus 27 performs energization to the solenoid 53 of the injector 5 with the current waveform shown in FIG. 6(B), for example, the one calculated in the calculating section 103n is selected by the similar selecting operation.

In the present embodiment, calculation of the valve response delay time to the current waveform change of three patterns is described, but the number of change patterns of the current waveform is not limited to three, but may be compatible with a larger number of patterns.

As a concrete example, when the valve response delay time calculating unit 103 and the selector unit 106 perform change of setting of the current waveform and the current value, which increases the electro magnetic force which is generated at the early stage of the valve opening of the injector 5 to be larger than usual, change of setting of the current waveform and the current value, which supplies the current of such a degree that does not open the injector 5 before the drive timing of the injector 5, or change of setting of the current waveform and the current value, which increases the current to be supplied to the injector 5 from the high voltage power supply VH, the valve response delay time TSd is made shorter than usual.

Further, when the valve response delay time calculating unit 103 and the selector unit 106 perform change of setting of the current waveform and the current value, which reduces the electro magnetic force which is generated just before the injector 5 closes, to be smaller than usual, change of setting of the current waveform and the current value, which reduces the current which is supplied to the injector 5 from the low voltage power supply VB, to be less than usual, or change of setting of the current waveform and the current value which supplies a current in the opposite direction from the current before cutoff when the current which is supplied to the injector 5 from the low voltage power supply VB is cut off, the valve response delay time TSd is made longer than usual.

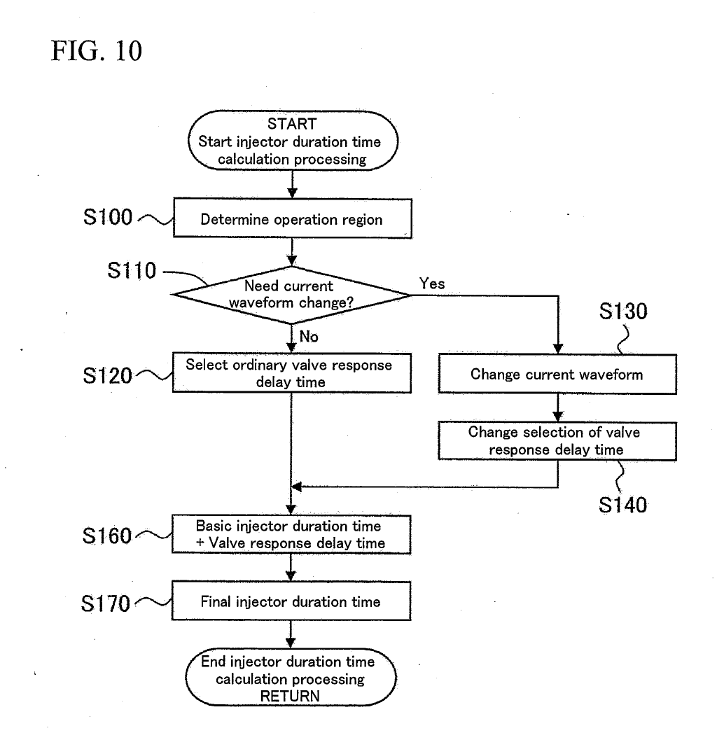

Next, the fuel injection control flow by the fuel injection control apparatus 27 of the present embodiment will be described with reference to a flowchart of FIG. 10.

During the operation of the engine 1, the ECU 9 determines what operation region the engine 1 is in (step S100). Examples of the index of determination include the speed of the engine 1, the intake air amount and the like.

Next, the ECU 9 determines whether or not it is necessary to change the setting of the current waveform and the current value of the current for energizing the solenoid 53 of the injector 5 based on the determination of the operation region of the engine 1 (step S110). When it is determined that the change of setting of the current waveform and the current value is unnecessary, the normal valve response delay time calculation result is selected (step S120).

In contrast to this, when it is determined that the change is necessary, instruction for changing the current waveform and the current value is given to the injector driver IC 56 from the CPU 57 via the communication line 54 (step S130).

The injector driver IC 56 follows the instruction of the ECU 9, and changes the setting so as to be able to pass the current of the current waveform as shown in, for example, FIG. 3(B), FIG. 4(A) and FIG. 6(B) to the solenoid 53. Subsequently, the CPU 57 selects the valve response delay time corresponding to the current waveform after the change among the valve response delay times calculated in the calculating sections 103a to 103n of the valve response delay time calculating unit 103 (step S140).

Next, the valve response delay time calculated in step S120 or step S140 is added to a basic injector duration time calculated by a separate calculation sequence (step S160), and this is set as the final injector duration time, and the injector duration time for energizing the solenoid 53 of the injector 5 is determined (step S170).

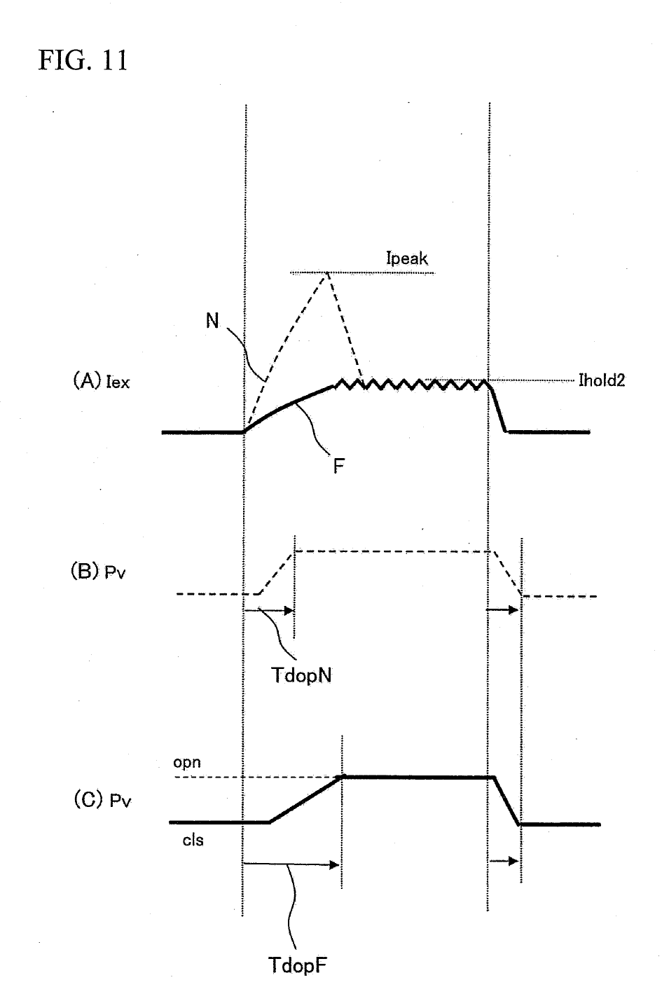

Next, the energizing current flowing to the solenoid 53 of the injector 5 when the high voltage power supply VH fails in the fuel injection control apparatus 27 according to the present embodiment will be described with reference to FIG. 11.

The current waveform during the normal time is a current waveform shown by the dotted line N of FIG. 11(A). When the high voltage power supply VH fails, the energizing current Iex of the peak current value Ipeak shown in FIG. 11(A) cannot be supplied. Therefore, in this case, the energizing current Iex by the second keeping current value Ihold2 is supplied from the low voltage power supply VB to open the injector 5 and keep the injector 5 open.

At this time, since the energizing current Iex of the peak current value Ipeak is not supplied, the electro magnetic force at the early stage of the valve opening of the injector 5 is small, and a valve opening delay TdopF becomes larger than the valve opening delay TdopN at the normal time. Therefore, at the time of the failure of a high voltage, the injector duration time to the solenoid 53 of the injector 5 is made longer by the amount of increase in the valve opening delay, and thereby the same fuel injection quantity as at the normal time can be realized.

For this, as described by using FIGS. 9 and 10, when the current waveform is changed so as to supply the current to the solenoid 53 of the injector 5 from only the low voltage power supply at the time of a failure of the high voltage power supply, the result of calculation of the valve response delay time is switched by the selector unit 106, and thereafter, the valve response delay time is added to the basic injector duration time, whereby the final injector duration time can be calculated.

Thus, the correction amount for correcting the valve opening/closing delay is changed in accordance with the change of setting of the current waveform and the current value, and the injector duration time for the solenoid 53 of the injector 5 is changed. According to such a configuration, at the time of changing the current waveform and the current value of the current which is supplied to the solenoid 53 of the injector 5, the fuel injection quantity precision also can be maintained and enhanced.

The embodiments of the present invention are described in detail above, but the present invention is not limited to the above described embodiments. Further, the respective components are not limited to the above described configurations as long as they do not impair the characteristic function of the present invention.

What is claimed is:

1. A control apparatus for an internal combustion engine which converts an injection quantity of a fuel which is supplied to the internal combustion engine into a valve opening duration time of an electromagnetic type injector, calculates a valve opening/closing delay of said injector as a correction time, corrects said valve opening duration time in accordance with said correction time to control an injector duration time of said injector, and controls a fuel injection quantity, comprising
current waveform/current set value changing portion which can change a setting of at least any one of a current waveform or a current value of a current which is supplied to said injector; and
valve response delay time calculating portion which variably sets said correction time for correcting an opening/closing delay of said injector in accordance with a change of setting of the current waveform and the current value by said current waveform/current set value changing portion.

2. The control apparatus for an internal combustion engine according to claim 1,
wherein energization control is performed, for supplying a current to said injector from a high voltage power supply to open said injector by an electro magnetic force generated by the current, and thereafter, supplying a current to said injector from a low voltage power supply in place of said high voltage power supply to maintain the valve opening of the injector.

3. The control apparatus for an internal combustion engine according to claim 1,
wherein said current waveform/current set value changing portion performs change of setting of the current waveform and the current value for increasing an electro magnetic force generated at an early stage of valve opening of said injector to be larger than usual, and
said valve response delay time calculating portion makes said correction time shorter than usual in accordance with the change of setting of the current waveform and current value.

4. The control apparatus for an internal combustion engine according to claim 1,
wherein said current waveform/current set value changing portion performs change of setting of a current waveform and a current value for supplying a current of such a degree that does not open said injector before a drive timing of said injector, and
said valve response delay time calculating portion makes said correction time shorter than usual in accordance with the change of setting of the current waveform and the current value.

5. The control apparatus for an internal combustion engine according to claim 2,
wherein said current waveform/current set value changing portion performs change of setting of a current waveform and a current value for increasing the current which is supplied to said injector from said high voltage power supply to be more than usual, and
said valve response delay time calculating portion makes said correction time shorter than usual in accordance with the change of setting of the current waveform and the current value.

6. The control apparatus for the internal combustion engine according to claim 1,
wherein said current waveform/current set value changing portion performs change of setting of a current waveform and a current value for decreasing an electro magnetic force, which is generated just before said injector closes, to be smaller than usual, and
said valve response delay time calculating portion makes said correction time longer than usual in accordance with the change of setting of the current waveform and the current value.

7. The control apparatus for an internal combustion engine according to claim 2,
wherein said current waveform/current set value changing portion performs change of setting of a current waveform and a current value for decreasing a current which is supplied to said injector from said low voltage power supply to be less than usual, and
said valve response delay time calculating portion makes said correction time longer than usual in accordance with the change of setting of the current waveform and the current value.

8. The control apparatus for an internal combustion engine according to claim 2,
wherein said current waveform/current set value changing portion performs change of setting of a current waveform and a current value for supplying a current in an opposite direction from a current before cut off at a time of cutting off the current which is supplied to said injector from said low voltage power supply, and
said valve response delay time calculating portion makes said correction time longer than usual in accordance with the change of setting of the current waveform and the current value.

9. The control apparatus for an internal combustion engine according to claim 2,
wherein it is determined whether or not said high voltage power supply is normal;
when it is determined that said high voltage power supply is not normal, said current waveform/current set value changing portion performs change of setting of a current waveform and a current value for stopping current supply from the high voltage power supply, and supplying a current to said injector from only the low voltage power supply, and
said valve response delay time calculating portion makes said correction time longer than usual in accordance with the change of setting of the current waveform and the current value.

10. A control method for an internal combustion engine for controlling a fuel injection quantity by converting an injection quantity of a fuel which is supplied to the internal combustion engine into a valve opening duration time of an electromagnetic type injector, calculating a valve opening/closing delay of said injector as a correction time, and correcting said valve opening duration time in accordance with said correction time to control an injector duration time of said injector,
wherein said correction time for correcting the opening and closing delay of said injector is changed in accordance with change of setting of at least any one of a current waveform or a current value of a current which is supplied to said injector.
